(19) United States
(12) Patent Application Publication
(10) Pub. No.: US 2010/0124419 A1
(43) Pub. Date: May 20, 2010

(54) ELECTRICAL CONNECTOR DEVICE

(75) Inventor: SHOU-SHU KAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/506,336

(22) Filed: Jul. 21, 2009

(30) Foreign Application Priority Data
Nov. 20, 2008 (CN) 200810305671.3

(51) Int. Cl. H04B 10/20

(52) U.S. Cl. 398/58; 385/15; 385/46

(57) ABSTRACT

The invention discloses an electrical connector device, which includes an optic fiber hub and a plurality of electrical embedded interfaces connected to the optic fiber hub. The optic fiber hub is connected to monitoring equipments or communication networks, and the electrical embedded interfaces are installed electrical devices and connected to the optic fiber hub, such that the electrical devices can transmit data and instructions to the monitoring equipments, the communication networks or each other by the electrical connector device.

### BACKGROUND

1. Technical Field

The disclosure relates to electrical connector devices, particularly, to an electrical connector device applying to varieties of electrical devices to transmit data.

2. Description of Related Art

Different types of electrical devices use the different types of connectors and data transmission standards, so that varieties of connectors and switches are needed to connect different electrical devices, it is very complex for implementation and not practical to use so many electrical connectors.

Therefore, there is a room for improvement within the art.

### BRIEF DESCRIPTION OF THE DRAWINGS

Many aspects of an electrical connector device can be better understood with reference to the following drawings. The components in the drawings are not necessarily to scale, the emphasis instead being placed upon clearly illustrating the principles of the present electrical connector device. Moreover, in the drawings, like reference numerals designate corresponding parts throughout the several views, in which:

FIG. 1 is a star topology connection view of an electrical connector device, in accordance with an exemplary embodiment;

FIG. 2 is a function diagram of an optic fiber hub of the electrical connector device shown in FIG. 1;

FIG. 3; is a function diagram of an electrical embedded interface of the electrical connector device shown in FIG. 1; and

FIG. 4 is a mix physical topology connection view of an electrical connector device, in accordance with another embodiment.

### DETAILED DESCRIPTION OF THE EMBODIMENTS

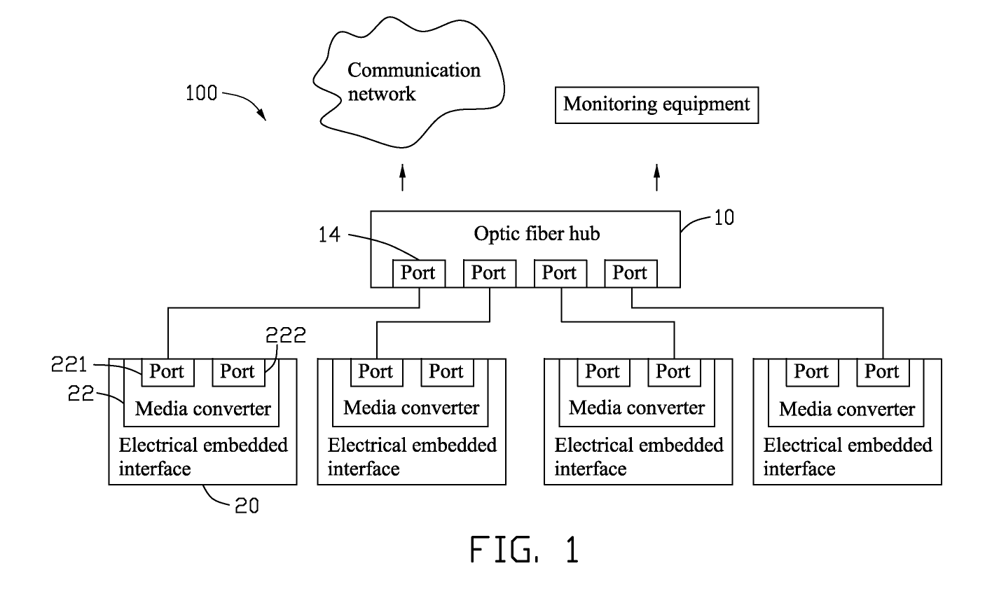

Referring to FIG. 1, an electrical connector device 100 includes an optic fiber hub 10 and a plurality of electrical embedded interfaces 20 connected to the optic fiber hub 10. The electrical embedded interfaces 20 can be installed into varieties of electrical devices, so that the electrical devices are connected to the optic fiber hub 10. The optic fiber hub 10 is connected to Internet, a telephone network, a cable television network and other communication networks or monitoring equipments, so that the electrical devices can be connected to the Internet, telephone network, cable television network and other communication networks or the monitoring equipments via the electrical connector device 100.

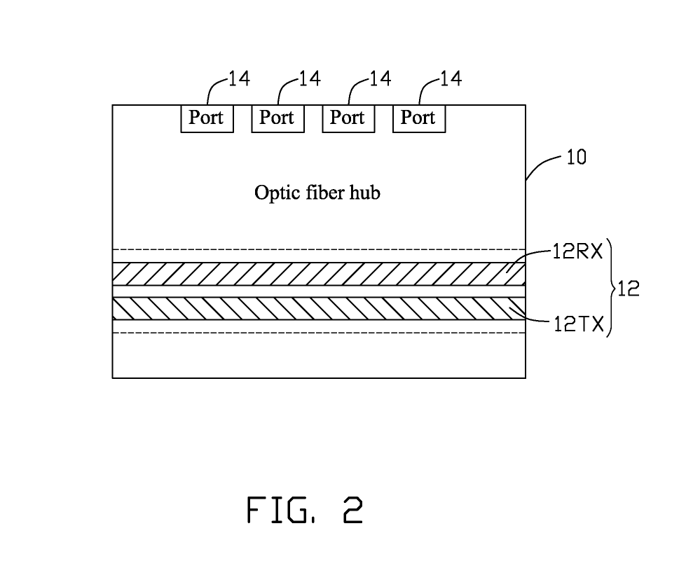

Referring to FIG. 2, the optic fiber hub 10 includes at least one multi-purpose optic cable line 12 and several fiber optic communication ports 14. The multi-purpose optic cable line 12 follows the IEEE802.3Z technical standard, which defines the specifications using the multi-purpose optic fiber in the 1 Gigabit (GBit) bandwidth, and the bandwidth is sufficient for different electrical devices to transmit data each other. The multi-purpose optic cable line 12 includes a receiving port 122 and a transmitting port 124, and each multi-purpose optic cable line 12 can be connected to the monitoring equipments or communication networks, so that the communication ports 14 can transmit data to the monitoring equipments and communication networks via the multi-purpose optic cable line 12. Each communication port 14 is connected to the electrical embedded interfaces 20, which connects the electrical devices to the optic fiber hub 10.

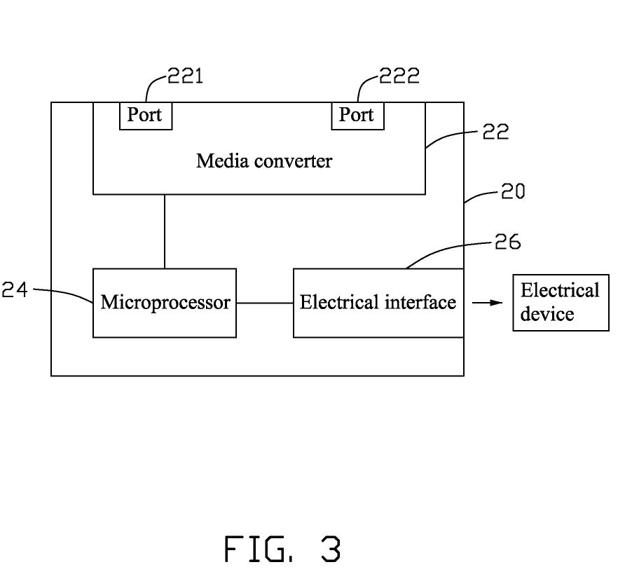

Referring to FIG. 3, each electrical embedded interface 20 includes a media converter 22, a microprocessor 24 and an electrical interface 26. The media converter 22 is used to convert optical signals used by the optic fiber hub 10 into electric signals used by the electrical devices, and is also used to convert the electric signals into optical signals, so that the electrical connector device 100 uses the same standard signals to facilitate the signal transmission. The media converter 22 includes at least two fiber optic communication ports 221 and 222. The ports 221 or 222 are connected to one port 14 of the optic fiber hub 10 so as to transmit data and instructions between the optic fiber hub 10 and the electrical devices. Any two ports 221 and 222 correspondingly to two electrical embedded interfaces 20 can be interconnected to transmit data and instructions between two electrical devices. The microprocessor 24 is connected to the media converter 22 and the electrical interface 26 in order to process the data and instructions transmitted between the electrical devices and the monitoring equipments or communication networks. The microprocessor 24 is used to assign the data and instructions to different function modules, such as central process unit (CPU), monitors, memories, and audio circuits, of the electrical devices or transmit the data and instructions to the different communication network, such as the Internet, telephone network, and cable television (TV) network. The electrical interface 26 is connected to internal circuits of the electrical devices to transmit the data and instructions between the electrical devices and the communication networks or the monitoring equipments.

Further referring to FIG. 1, the electrical connector device 100 has a variety of connection manners. In the star topology connection manner, each electrical embedded interface 20 is installed in one electrical device, and the communication ports 221 of the electrical embedded interfaces 20 are connected to the different ports 14 of the optic fiber hub 10 in order to connect the electrical devices having the electrical embedded interfaces 20 to the optic fiber hub 10. In use, if the optic fiber hub 10 is connected to the monitoring equipment, so that the monitoring equipment can monitor and control the electrical devices connected to the electrical connector device 100. If the optic fiber hub 10 is connected to the Internet, telephone network, cable television or other communication networks, then all the electrical devices connected to the electrical connector device 100 are connected to the communication networks to upload or download data and instructions, and different electrical devices can transmit data and instructions each other through the communication networks. In the course of using the electrical connecter device 100, the microprocessor 24 of each electrical embedded interface 20 receives the data and instructions from the monitoring equipment or the communication network, and then assign the data and instructions to the corresponding function module of the electrical devices installed in the electrical embedded interfaces 20. The microprocessor 24 also can receive the data and instructions from the electrical devices, and then transmits the data and instructions to different monitoring equipments or communication networks.

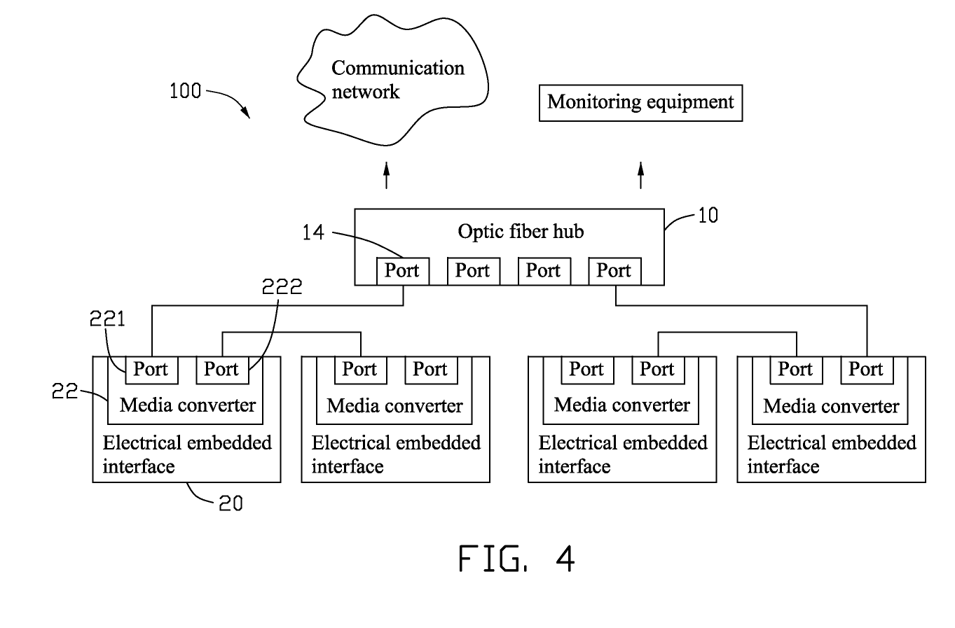

Further referring to FIG. 4, in the mix physical topology connection manner, the electrical embedded interfaces 20 can be directly connected to the optic fiber hub 10 and also can be indirectly connected to the optic fiber hub 10. When the electrical embedded interfaces 20 are directly connected to the optic fiber hub 10, each port 221 of the electrical embedded interfaces 20 is connected to the port 14 of the optic fiber hub 10. When the electrical embedded interfaces 20 are indirectly connected to the optic fiber hub 10, arbitrary one port 221 or 222 of the electrical embedded interfaces 20 is connected to the port 222 of the electrical embedded interfaces 20 directly connected to the hub 10. Thereby, if the electrical devices are use to transmit data and instructions, then the electrical devices can be firstly connected to electrical embedded interfaces 20, then the electrical embedded interfaces 20 are respectively connected to other electrical interfaces 20 connected to the optic fiber hub 10 via the ports 221/222. On the other hand, if the electrical embedded interfaces 20 interconnect each other via the ports 221/222, then the electrical devices having the electrical embedded interfaces 20 can directly transmit datum each other via the ports 221/22, so that the datum are not transferred by the optic fiber hub 10, and the datum can be directly transmitted from one electrical device to another electrical device. For instance, the TV is firstly connected to varieties of digital subscriber line (XDSL) terminals, and then the XDSL terminals are further connected to the cable TV network through the optic fiber hub 10 in order to improve the video signals of the TV. The telephone, refrigerator or other electrical device is firstly connected to one electrical embedded interface 20, and the computer is connected to another electrical embedded interface 20, both the two electrical embedded interfaces 20 are interconnected via the ports 221/222. Thereby, the computer can directly control the electrical devices. When the computer is accessed to Internet or other wireless communication networks through the optic fiber hub 10, then the computer sends a control signal to a electrical device via the wireless communication network, so that the electrical devices can be remotely controlled by the computer.

The optic fiber hub 10 of the electrical connector device 100 follows the IEEE802.3Z technical standard, and the electrical connector device 100 connects different types electrical devices to different communication networks or monitoring equipments to easily transmit data and instructions and monitor varieties of electrical devices. The electrical connector device 100 can connect the electrical devices to communication networks or other electrical devices to transmit data and instructions to facilitate the use of the electrical devices.

It is to be understood, however, that even through numerous characteristics and advantages of the present disclosure have been set forth in the foregoing description, together with details of the structure and function of the invention, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electrical connector device used for transmitting data and instructions from an electronic device to a monitoring equipment or a communication network, the electrical connector device comprising:
an optic fiber hub connected to the monitoring equipment or the communication network; and
a plurality of electrical embedded interfaces installed in the electrical device and connected to the optic fiber hub.

2. The electrical connector device as claimed in claim 1, wherein the optic fiber hub includes at least one multi-purpose cable lines and a plurality of ports connected to the multi-purpose cable lines and the electrical embedded interfaces.

3. The electrical connector device as claimed in claim 2, wherein the connection manner of the multi-purpose cable lines follows the technical standard IEEE802.3Z.

4. The electrical connector device as claimed in claim 2, wherein each electrical embedded interface includes a media converter which includes at least two ports connected to the ports of the optic fiber hub.

5. The electrical connector device as claimed in claim 4, wherein one port of each electrical embedded interface is connected to one port of the optic fiber hub to constitute a star topology connection structure.

6. The electrical connector device as claimed in claim 4, wherein one port of each electrical embedded interface is connected to one port of the optic fiber hub, and another port of each electrical embedded interface is connected to one port of another electrical embedded interface, so as to constitute a max physical topology connection structure.

7. The electrical connector device as claimed in claim 4, wherein each electrical embedded interface further includes a microprocessor connected to the media converter, the microprocessor is used to process the data and instructions transmitted between the electrical devices and monitoring equipments or communication networks, and assign the data and instructions to corresponding function modules, or transmit the data and instructions to the different communication networks.

8. The electrical connector device as claimed in claim 7, wherein the electrical embedded interface further includes an electrical interface connected to the microprocessor, and the electrical interface is connected to internal circuits of the electrical devices to transmit the data and instructions to the internal circuits to be processed and implemented.

9. An electrical connector device used for transmitting data and instructions form an electrical device to a monitoring equipment or a communication network, the electrical connector device comprising:
an optic fiber hub comprising a plurality of ports connected to the monitoring equipment or the communication network; and
a plurality of electrical embedded interfaces installed in the electrical devices and connected to the ports of the optic fiber hub;

10. The electrical connector device as claimed in claim 9, wherein the optic fiber hub includes at least one multi-purpose cable lines, the multi-purpose cable lines are connected to the ports of the optic fiber hub.

11. The electrical connector device as claimed in claim 10, wherein the connection manner of the multi-purpose cable lines follows the technical standard IEEE802.3Z.

12. The electrical connector device as claimed in claim 10, wherein each electrical embedded interface includes a media converter which includes at least two ports connected to the ports of the optic fiber hub.

13. The electrical connector device as claimed in claim 12, wherein one port of each electrical embedded interface is connected to one port of the optic fiber hub to constitute a star topology connection structure.

14. The electrical connector device as claimed in claim 12, wherein one port of each electrical embedded interface is connected to one port of the optic fiber hub, and another port of each electrical embedded interface is connected to one port of another electrical embedded interface, so as to constitute a max physical topology connection structure.

15. The electrical connector device as claimed in claim 12, wherein each electrical embedded interface further includes a microprocessor connected to the media converter, the microprocessor is used to process the data and instructions transmitted between the electrical devices and monitoring equipments or communication networks, and assign the data and instructions to corresponding function modules, or transmit the data and instructions to the different communication network.

16. The electrical connector device as claimed in claim 15, wherein each electrical embedded interface further includes an electrical interface connected to the microprocessor, and the electrical interface is connected to internal circuits of the electrical devices to transmit the data and instructions to the internal circuits.

17. An electrical connector device used for transmitting data and instructions from an electronic device to a monitoring equipment or a communication network, the electrical connector device comprising:
an optic fiber hub comprising a plurality of ports connected to the monitoring equipment or the communication network; and
a plurality of electrical embedded interfaces comprising at least two ports, a microprocessor and electrical interface connected to the microprocessor, the ports being installed in the electrical devices and connected to the ports of the optic fiber hub;
wherein the electrical devices transmit data and instructions to the monitoring equipments, communication networks or each other via the electrical connector device, and the microprocessor processes the data and instructions, and assigns the data and instructions to corresponding function modules through the electrical interface, or transmits the data and instructions to the different communication networks.

18. The electrical connector device as claimed in claim 17, wherein each electrical embedded interface includes a media converter, the at least two ports are set into the media converter.

19. The electrical connector device as claimed in claim 17, wherein one port of each electrical embedded interface is connected to one port of the optic fiber hub to constitute a star topology connection structure.

20. The electrical connector device as claimed in claim 17, wherein one port of each electrical embedded interface is connected to one port of the optic fiber hub, and another port of each electrical embedded interface is connected to one port of another electrical embedded interface, so as to constitute a max physical topology connection structure.
